(19) United States
(12) Patent Application Publication
(10) Pub. No.: US 2026/0287742 A1
(43) Pub. Date: Sep. 24, 2026

(54) DEVICE AND METHOD FOR DETECTING TOPOGRAPHY OF DEEP UNDERGROUND HORIZONTAL ROCK-SALT CAVERN

(71) Applicant: Taiyuan University of Technology, Taiyuan City (CN)

(72) Inventors: Shengli ZHANG, Taiyuan City (CN); Weiguo LIANG, Taiyuan City (CN); Ning XIAO, Taiyuan City (CN); Zuyi XIANG, Taiyuan City (CN); Suguo XU, Taiyuan City (CN); Jing LI, Taiyuan City (CN)

(21) Appl. No.: 19/184,092

(22) Filed: Apr. 21, 2025

(30) Foreign Application Priority Data
Mar. 21, 2025 (CN) 202510336084.4

(51) Int. Cl. G01S 15/89; B63G 8/00; B63G 8/39

(52) U.S. Cl. CPC G01S 15/89; B63G 8/001; B63G 8/39

(57) ABSTRACT

A device and method for detecting a topography of a deep underground horizontal rock-salt cavern. The detection device includes a detector and a ground monitoring system connected to and communicated with the detector through an optical fiber cable; the ground monitoring system includes a ground center console and a monitor connected to the ground center console; the detector includes a cabin, a propulsion system, a battery pack, a control system, a sonar detector, a positioning system and an obstacle avoidance system; the battery pack and the control system are installed in the cabin; the sonar detector is installed at a front end of the cabin; the obstacle avoidance system includes infrared distance sensors installed at the front end of the cabin; and the propulsion system, the sonar detector, the positioning system and the obstacle avoidance system are connected to the control system via a signal.

### CROSS-REFERENCE TO RELATED APPLICATION

This patent application claims the benefit and priority of Chinese Patent Application No. 202510336084.4 filed with the China National Intellectual Property Administration on Mar. 21, 2025, the disclosure of which is incorporated by reference herein in its entirety as part of the present application.

### TECHNICAL FIELD

The present disclosure relates to the technical field of detection devices of rock-salt cavities, and in particular to a device and method for detecting a topography of a deep underground horizontal rock-salt cavern.

### BACKGROUND

Currently, China, the world's top carbon emitter, has been vigorously promoting the use of clean energy sources such as wind, solar and natural gas in order to achieve the goal of carbon neutrality by 2060. However, solar and wind energy are affected by the season, weather, day and night changes and other factors, and they themselves also need supporting energy storage systems to realize grid-connected power generation and autonomous peak load regulation, while natural gas mainly relies on foreign imports. Therefore, in order to solve the problem of energy storage of new energy sources, and to ensure the safety of traditional energy reserves, the construction of underground gas storages should not be delayed.

Rock-salt is internationally recognized as an ideal place for energy reserves because of its low permeability, good rheology and certain self-healing ability. China's rock-salt resources are abundant and widely distributed, with proven geological reserves exceeding 4,450 billion tons at depths ranging from tens of meters to 4 km, which has good geological conditions for the construction of underground energy storage caverns. In order to speed up the construction of underground rock-salt storage caverns, a traditional single-well convective cavern construction method has been replaced by a double-well convective cavern construction method, and large horizontal rock-salt cavities left over from the mining of salt mines have been fully utilized as gas storages. No matter whether a new horizontal cavern or an old horizontal rock-salt cavern is used as a storage cavern, its topography must be detected before its stability and economy can be judged, and finally a conclusion is given as to whether it can be used as a gas storage. However, a current cavern measurement device can only achieve topography measurement of a vertical cavern, and the topography measurement of a horizontal cavern is still in the exploration stage.

Therefore, there is an urgent need in the art for a topography detection device of a horizontal rock-salt cavern to achieve detection and measurement of the topography of the horizontal rock-salt cavern.

### SUMMARY

An objective of the present disclosure is to provide a device and method for detecting a topography of a deep underground horizontal rock-salt cavern to solve the above problems in the prior art, so as to realize detection and measurement of the topography of the horizontal rock-salt cavern.

To achieve the above objective, the present disclosure provides the following solutions.

The present disclosure provides device for detecting a topography of a deep underground horizontal rock-salt cavern, including a detector and a ground monitoring system, wherein the ground monitoring system is connected to and communicated with the detector through an optical fiber cable;
the ground monitoring system includes a ground center console and a monitor, the ground center console is provided with a video interface, and the ground center console is connected to the monitor via the video interface; the ground monitoring system includes a ground center console and a monitor, the ground center console is provided with a video interface, and the ground center console is connected to the monitor via the video interface;
the detector comprises a cabin, a propulsion system, a battery pack, a control system, a sonar detector, a positioning system and an obstacle avoidance system; the propulsion system comprises a horizontal three-dimensional vector propeller and a vertical propeller installed on the cabin; the battery pack and the control system are installed inside the cabin, and the battery pack supplies power to the propulsion system, the control system, the sonar detector, the positioning system and the obstacle avoidance system; the sonar detector is installed at a front end of the cabin; the positioning system comprises a gyroscope, a depthometer and a Doppler velocimeter, the gyroscope and the depthometer are arranged inside the cabin, and the Doppler velocimeter is arranged at a bottom of the cabin; the obstacle avoidance system comprises infrared distance sensors installed at the front end of the cabin; and the propulsion system, the sonar detector, the positioning system and the obstacle avoidance system are respectively connected to the control system via signals.

In an embodiment, the cabin includes an aluminum alloy cylindrical hollow cylinder and sealing caps fixed to a front end and a rear end of the aluminum alloy cylindrical hollow cylinder, a frame is fixedly arranged inside the cabin, and the battery pack and the control system are installed on the frame.

In an embodiment, the sealing caps are fixed to the aluminum alloy cylindrical hollow cylinder by welding, a line hole is formed on each sealing cap, and a seal ring is arranged between a line and the line hole to ensure the hermetic integrity of the sealing cap.

In an embodiment, a waterproof and corrosion-resistant coating is coated outside the aluminum alloy cylindrical hollow cylinder, and the frame is made of polypropylene.

In an embodiment, the aluminum alloy cylindrical hollow cylinder is configured to have an outer diameter of 120 mm, a length of 1.2 m and a wall thickness of 12 mm.

In an embodiment, two sides and a middle of the front end of the cabin are each provided with one of the infrared distance sensors.

In an embodiment, the control system includes a main control board, a power module, a power supply module, an obstacle avoidance module, a measurement module, a positioning module and a data storage module, and the power module, the power supply module, the obstacle avoidance module, the measurement module, the positioning module and the data storage module are connected to the main control board via signals.

In an embodiment, the battery pack is a lithium battery pack.

In an embodiment, the sonar detector is configured to have a maximum working pressure of 40 MPa and a maximum working temperature of 100°C.

The present disclosure also provides a method for detecting a topography of a deep underground horizontal rock-salt cavern, based on the device for detecting a topography of a deep underground horizontal rock-salt cavern, including:
S1, selecting, according to geological information of salt mining and cavern construction, a horizontal rock-salt cavern to be detected;
S2, performing a workover operation on a shaft of the horizontal rock-salt cavern and filling the horizontal rock-salt cavern with water to ensure that the detector is smoothly lowerable, can travel in the cavern and is recoverable;
S3, lowering the detector from the shaft, and turning on the ground monitoring system and the positioning system during the lowering to monitor a lowering position in real time;
S4, turning on the propulsion system, the sonar detector and the obstacle avoidance system after the detector is lowered into the horizontal rock-salt cavern, the detector, while traveling in the horizontal rock-salt cavern, scanning the topography of the horizontal rock-salt cavern through the sonar detector, and transmitting real-time detection data to the ground center console through the optical fiber cable, and performing three-dimensional reconstruction to obtain the topography of the cavern;
S5, turning off the sonar detector upon completion of the detection, planning an optimal return path based on the topography of the horizontal cavern obtained in S4 and data of the positioning system, and giving an instruction through the ground center console to control the detector to return to the shaft;
S6, distributing power of the propulsion system through the ground center console, adjusting an attitude of the detector to cause the detector to be parallel to the shaft, and removing the detector from the shaft through the optical fiber cable; and
S7, processing and analyzing information stored in the ground center console to obtain a shape, a size and a volume of the horizontal rock-salt cavern, so as to complete the detection.

Compared with the conventional art, the present disclosure has the following technical effects.

According to the present disclosure, the detector is lowered into the horizontal rock-salt cavern through the shaft, the position of the detector is fed back by the positioning system in the detector, the detector can travel freely in the cavern by using the propulsion system, and automatic obstacle avoidance and cavern topography scanning are completed by the obstacle avoidance system and the sonar detector. The detection and scanning data are transmitted to the ground center console by means of the optical fiber cable for three-dimensional reconstruction to obtain the topography of the cavern. The information stored in the ground center console is processed and analyzed to obtain the shape, the size and the volume of the horizontal rock-salt cavern, so as to realize detection and measurement of the topography of the horizontal rock-salt cavern.

### BRIEF DESCRIPTION OF THE DRAWINGS

To illustrate the technical solutions in the embodiments of the present disclosure or conventional art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic structural diagram of a detector according to an embodiment of the present disclosure;

FIG. 2 is a schematic diagram of a partial section structure of the detector according to an embodiment of the present disclosure;

FIG. 3 is a schematic diagram of a device for detecting a topography of a deep underground horizontal rock-salt cavern during detection according to an embodiment of the present disclosure; and

FIG. 4 is a schematic principle diagram of a control system according to an embodiment of the present disclosure.

In the figures: 100-device for detecting of deep underground horizontal rock-salt cavern, 1-detector, 2-ground monitoring system, 3-optical fiber cable, 4-cabin, 5-battery pack, 6-sonar detector, 7-horizontal three-dimensional vector propeller, 8-vertical propeller, 9-infrared distance sensor, 10-aluminum alloy cylindrical hollow cylinder, 11-sealing cap, 12-main control board, 13-power module, 14-power supply module, 15-obstacle avoidance module, 16-measurement module, 17-positioning module, 18-data storage module, 19-horizontal rock-salt cavern, 20-shaft.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the embodiments described are merely some rather than all of the embodiments of the present disclosure. On the basis of the examples of the present disclosure, all the other examples that would have been obtained by those of ordinary skill in the art without involving any inventive effort shall fall within the scope of protection of the present disclosure.

An objective of the present disclosure is to provide a device and method for detecting a topography of a deep underground horizontal rock-salt cavern to solve the above problems in the prior art, so as to realize detection and measurement of the topography of the horizontal rock-salt cavern.

To make the above objective, features and advantages of the present disclosure clearer and more comprehensible, the present disclosure is further described in detail below with reference to the accompanying drawings and specific implementations.

### Embodiment 1

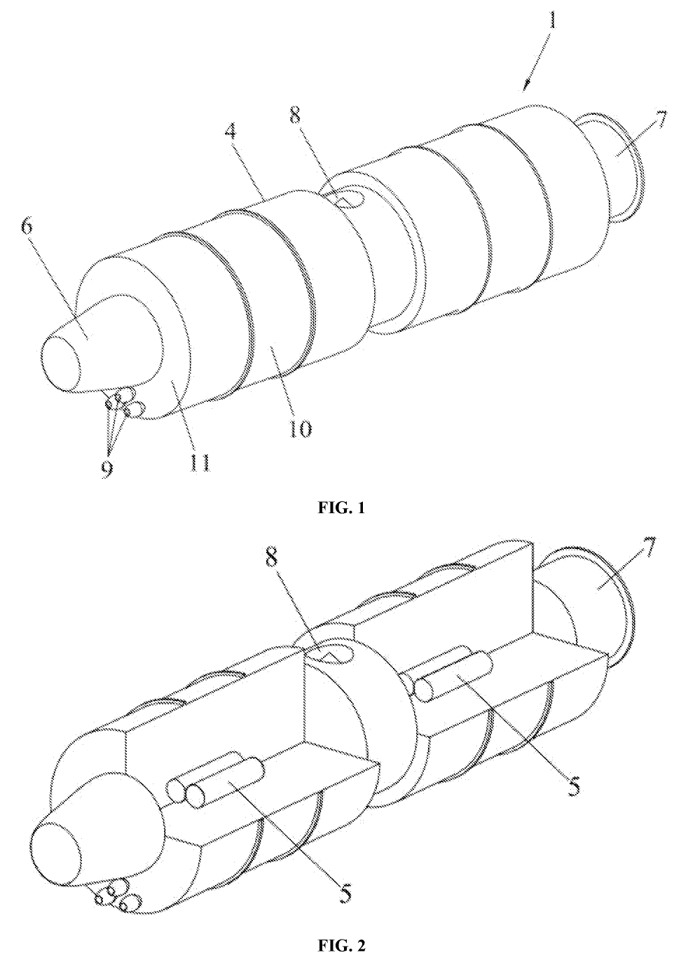

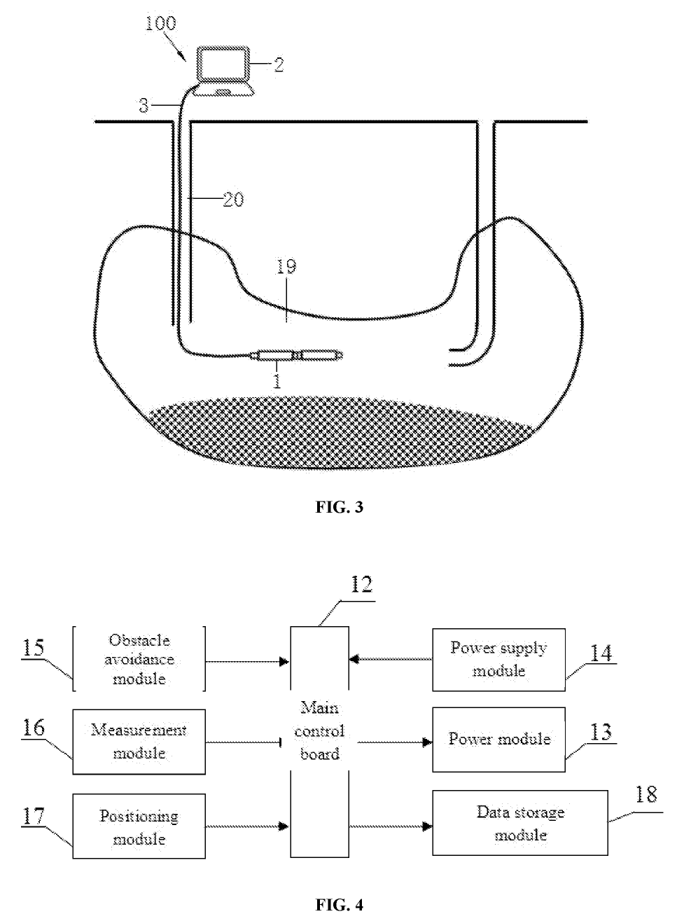

As shown in FIGS. 1-4, this embodiment provides a device 100 for detecting a topography of a deep underground horizontal rock-salt cavern, including a detector 1 and a ground monitoring system 2. The ground monitoring system 2 is connected to and communicated with the detector 1 through an optical fiber cable 3.

The ground monitoring system 2 includes a ground center console and a monitor. The ground center console is provided with an external serial port and a video interface. The ground center console is connected to the optical fiber cable 3 via the external serial port, and communicates with the detector 1 through the optical fiber cable 3. The ground center console is connected to the monitor via the video interface, such that a three-dimensional reconstructed image of the cavern can be output in real time.

The optical fiber cable 3 is configured to deliver a control signal, sonar detection information and sensor information in the detector 1, and may also retract the detector 1 from a shaft 20. The optical fiber cable 3 has a density close to that of brine, and is a self-levitating optical fiber cable, thereby reducing energy loss of the detector 1 dragging the optical fiber cable 3.

The detector 1 includes a cabin 4, a propulsion system, a battery pack 5, a control system, a sonar detector 6, a positioning system and an obstacle avoidance system. The propulsion system includes a horizontal three-dimensional vector propeller 7 and a vertical propeller 8 installed on the cabin 4, which can realize advancing, retracting, steering, and upward and downward operations of the detector 1 in the cavern. The battery pack 5 and the control system are installed inside the cabin 4, the battery pack 5 supplies power to the propulsion system, the control system, the sonar detector 6, the positioning system and the obstacle avoidance system, the battery pack 5 is a lithium battery pack, and the sonar detector 6 is installed at a front end of the cabin 4. The positioning system includes a gyroscope, a depthometer and a Doppler velocimeter, the gyroscope and the depthometer are arranged inside the cabin 4, and the Doppler velocimeter is arranged at a bottom of the cabin 4. The sonar detector 6 transmits a result of scanning to the ground center console through the optical fiber cable 3 to complete three-dimensional reconstruction of the cavern and to preliminarily determine the position of the detector 1 in the detected cavern. The gyroscope determines a true north direction from the gravitational field and rotational angular velocity of the earth, providing a heading reference for the detector 1. The depthometer determines the depth of the detector 1 based on pressure and sound waves. The Doppler velociometer determines the speed of movement of the detector 1 based on the difference of frequency between emitted and reflected electromagnetic waves. Measurement data is input into the control system through the positioning system, and the control system transmits the data to the ground center console through the optical fiber cable 3 to provide data support for the movement of the detector 1 in the cavern. The obstacle avoidance system includes infrared distance sensors 9 installed at the front end of the cabin 4, two sides and a middle of the front end of the cabin 4 are each provided with one infrared distance sensor 9, and the three infrared distance sensors 9 respectively detect fan-shaped areas in the front left, the front and the right front, and transmit real-time detection information to the control system, and the control system calculates the direction and the rate of the propulsion system according to a fuzzy control rule, thereby achieving the obstacle avoidance function. The propulsion system, the sonar detector 6, the positioning system and the obstacle avoidance system are respectively connected to the control system via signals.

Limited by the rock-salt cavern construction and brine extraction process, the diameters of general cavern construction and brine extraction pipes are about 180 mm or 155 mm, and the diameter of a pipe column gradually decreases with the increase of operation time. Therefore, in order to ensure that the detector 1 is smoothly lowered and retracted, the detector 1 is configured to have a maximum diameter not exceeding 120 mm and a length not more than 1.5 m. In this embodiment, the cabin 4 includes an aluminum alloy cylindrical hollow cylinder 10 and sealing caps 11 fixed to a front end and a rear end of the aluminum alloy cylindrical hollow cylinder 10, and the aluminum alloy cylindrical hollow cylinder 10 is configured to have an outer diameter of 120 mm, a length of 1.2 m and a wall thickness of 12 mm.

In this embodiment, a waterproof and corrosion-resistant coating is coated outside the aluminum alloy cylindrical hollow cylinder 10, so that the aluminum alloy cylindrical hollow cylinder 10 has waterproof and corrosion-resistant effects. The sonar detector 6, which meets a pressure resistance standard, is fixed to the front end of the cabin 4 to enable a 360° radial scanning for the topography of the cavern. The sonar detector 6 is configured to have a maximum working pressure of 40 MPa and a maximum working temperature of 100°C, and can transmit data to the control system in real time during detection. The detector 1 can work continuously in the cavern with a pressure not exceeding 40 MPa and a temperature not exceeding 100°C. The sealing caps 11 are fixed to the aluminum alloy cylindrical hollow cylinder 10 by high-pressure welding, a line hole is formed on each sealing cap 11, and a seal ring is arranged between a line and the line hole to ensure the hermetic integrity of the sealing cap11. A frame is fixedly arranged inside the cabin 4, the frame is made of polypropylene, and the battery pack 5 and the control system are installed on the frame.

In this embodiment, the control system includes a main control board 12, a power module 13, a power supply module 14, an obstacle avoidance module 15, a measurement module 16, a positioning module 17 and a data storage module 18, and the power module 13, the power supply module 14, the obstacle avoidance module 15, the measurement module 16, the positioning module 17 and the data storage module 18 are connected to the main control board 12 via signals. The center console is connected to the main control board 12 through the optical fiber cable 3, the obstacle avoidance module 15 is connected to the main control board 12 via a first input interface, the measurement module 16 is connected to the main control board 12 via a second input interface, and the positioning module 17 is connected to the main control board 12 via a third input interface, the power module 13 is connected to the main control board 12 via a first output interface, the power supply module 14 is connected to the main control board 12 via a second output interface, and the data storage module 18 is connected to the main control board 12 via a third output interface. The power module 13 is configured to regulate power distribution, including power distribution for the horizontal three-dimensional vector propeller 7 and the vertical propeller 8. The power supply module 14 reasonably distributes power from the battery pack 5 to the propulsion system, the control system, the sonar detector 6, the positioning system and the obstacle avoidance system. The obstacle avoidance module 15 is configured to analyze and process data of the infrared distance sensor 9 to achieve an automatic obstacle avoidance function. The measurement module 16 is configured to preliminary analyze and process the data of the sonar detector 6. The positioning module 17 is configured to comprehensively analyze and process data of the sonar detector 6, the gyroscope, the depthometer and the Doppler velocimeter to determine the position of the detector 1. The data storage module 18 is configured to temporarily store data collected through the obstacle avoidance module 15 and the measurement module 16.

In the present disclosure, the detector can be lowered into the horizontal cavern through the shaft to complete the measurement in a high-temperature and high-pressure environment and to return from the shaft, thereby avoiding the length constraints imposed by inclined shaft. Additionally, the detector is powered by its own onboard battery, thereby avoiding the problem of a voltage drop caused by long-distance ground power supply.

In the present disclosure, the propulsion system of the detector includes the horizontal three-dimensional vector propeller and the vertical propeller, which not only ensures that the detector can move freely in the horizontal direction of the cavern, but also realizes up-and-down movement according to sediment positions of the cavern.

In the present disclosure, the obstacle avoidance system of the detector includes three infrared distance sensors, namely a left infrared distance sensor, a middle infrared distance sensor and a right infrared distance sensor, and the kinetic energy of the propulsion system is distributed according to real-time data detected through the infrared distance sensors in combination with a fuzzy control rule, so as to realize automatic obstacle avoidance.

In the present disclosure, the detector, during cavern measurement, performs 360° radial scanning through the sonar while transmitting scanning information to the ground center console through the optical fiber cable to complete real-time three-dimensional topography reconstruction of the cavern, and the moving trajectory of the detector in the cavern is further guided according to the reconstructed topography.

### Embodiment 2

As shown in FIG. 3, this embodiment provides a method for detecting a topography of a deep underground horizontal rock-salt cavern. Based on the device 100 for detecting a topography of a deep underground horizontal rock-salt cavern described in Embodiment 1, a detector 1 is placed, from a shaft 20 with a diameter greater than 140 mm, into a horizontal rock-salt cavern 19 filled with brine, the position of the detector 1 in the cavern is determined according to its own positioning system and scanning data of a sonar detector 6, and monitoring personnel observes the detector and controls next movement of the detector through the ground monitoring system 2 to complete scanning and detection of the whole cavern. The specific etection process includes the following steps.

In S1, a horizontal rock-salt cavern 19 to be detected is selected according to geological information of salt mining and cavern construction, where the horizontal rock-salt cavern 19 is buried no deeper than 3,000 m and a length of the horizontal rock-salt cavern 19 is greater than 200 m and less than 1,000 m, and a bore diameter of the shaft 20 is greater than 140 mm.

In S2, a workover operation is performed on the shaft 20 of the horizontal rock-salt cavern 19 and the horizontal rock-salt cavern 19 is filled with water to ensure that the detector 1 is smoothly lowerable, is able to travel in the cavern, and is retractable.

In S3, the detector 1 is lowered from the shaft 20, and the ground monitoring system 2 and the positioning system are turned on during the lowering to monitor a lowering position in real time. A thrown object is suspended on the detector 1 during the lowering and the thrown object is thrown down when the detector 1 reaches the cavern.

In S4, the propulsion system, the sonar detector 6 and an obstacle avoidance system are turned on after the detector 1 is lowered into the horizontal rock-salt cavern 19, the detector 1, while traveling in the horizontal rock-salt cavern 19, performs 360° radial scanning on the topography of the horizontal rock-salt cavern 19 through the sonar detector 6, and real-time detection data is transmitted to the ground center console through the optical fiber cable 3, and three-dimensional reconstruction is performed to obtain the topography of the cavern. A ground operator gives reasonable drive instructions according to a three-dimensional reconstructed pattern and the positioning system to ensure that the detector 1 travels on a defined route. When encountering obstacles on the route of travel, the route of travel of the detector 1 is changed through the obstacle avoidance system and a human-assisted method so as to circumvent the obstacle.

In S5, the sonar detector 6 is turned off upon completion of the detection, an optimal return path is planned based on the topography of the horizontal cavern obtained in S4 and data of the positioning system, and instructions are given by the ground center console to control the detector 1 to return to the shaft 20 along a path with the least obstacles.

In S6, power of the propulsion system is distributed by the ground center console, an attitude of the detector 1 is adjusted to cause the detector 1 to be parallel to the shaft 20 to facilitate successful removal of the detector 1 from the shaft 20, and the detector 1 is removed from the shaft 20 through the optical fiber cable 3 after being adjusted to be in place.

In S7, information stored in the ground center console is finely processed and analyzed to obtain a precise shape, a precise size and a precise volume of the horizontal rock-salt cavern 19, so as to complete the detection.

In the present disclosure, the principle and implementations of the present disclosure are described herein by using specific examples, the above descriptions of the above embodiments are merely intended to help understand the methods and core idea of the present disclosure. In addition, for those of ordinary skill in the art, changes may be made to the specific embodiments and the scope of application according to the concept of the present disclosure. In summary, the content of the description should not be construed as a limitation to the present disclosure.

What is claimed is:

1. A device for detecting a topography of a deep underground horizontal rock-salt cavern, comprising a detector and a ground monitoring system, wherein the ground monitoring system is connected to and communicated with the detector through an optical fiber cable;
the ground monitoring system comprises a ground center console and a monitor, the ground center console is provided with a video interface, and the ground center console is connected to the monitor via the video interface;
the detector comprises a cabin, a propulsion system, a battery pack, a control system, a sonar detector, a positioning system and an obstacle avoidance system; the propulsion system comprises a horizontal three-dimensional vector propeller and a vertical propeller installed on the cabin; the battery pack and the control system are installed inside the cabin, and the battery pack supplies power to the propulsion system, the control system, the sonar detector, the positioning system and the obstacle avoidance system; the sonar detector is installed at a front end of the cabin; the positioning system comprises a gyroscope, a depthometer and a Doppler velocimeter, the gyroscope and the depthometer are arranged inside the cabin, and the Doppler velocimeter is arranged at a bottom of the cabin; the obstacle avoidance system comprises infrared distance sensors installed at the front end of the cabin; and the propulsion system, the sonar detector, the positioning system and the obstacle avoidance system are respectively connected to the control system via signals.

2. The device for detecting a topography of a deep underground horizontal rock-salt cavern according to claim 1, wherein the cabin comprises an aluminum alloy cylindrical hollow cylinder and sealing caps fixed to a front end and a rear end of the aluminum alloy cylindrical hollow cylinder, a frame is fixedly arranged inside the cabin, and the battery pack and the control system are installed on the frame.

3. The device for detecting a topography of a deep underground horizontal rock-salt cavern according to claim 2, wherein the sealing caps are fixed to the aluminum alloy cylindrical hollow cylinder by welding, a line hole is formed on each sealing cap, and a seal ring is arranged between a line and the line hole to ensure the hermetic integrity of the sealing cap..

4. The device for detecting a topography of a deep underground horizontal rock-salt cavern according to claim 2, wherein a waterproof and corrosion-resistant coating is coated outside the aluminum alloy cylindrical hollow cylinder, and the frame is made of polypropylene.

5. The device for detecting a topography of a deep underground horizontal rock-salt cavern according to claim 2, wherein the aluminum alloy cylindrical hollow cylinder is configured to have an outer diameter of 120 mm, a length of 1.2 m and a wall thickness of 12 mm.

6. The device for detecting a topography of a deep underground horizontal rock-salt cavern according to claim 1, wherein two sides and a middle of the front end of the cabin are each provided with one of the infrared distance sensors.

7. The device for detecting a topography of a deep underground horizontal rock-salt cavern according to claim 1, wherein the control system comprises a main control board, a power module, a power supply module, an obstacle avoidance module, a measurement module, a positioning module and a data storage module, and the power module, the power supply module, the obstacle avoidance module, the measurement module, the positioning module and the data storage module are connected to the main control board via signals.

8. The device for detecting a topography of a deep underground horizontal rock-salt cavern according to claim 1, wherein the battery pack is a lithium battery pack.

9. The device for detecting a topography of a deep underground horizontal rock-salt cavern according to claim 1, wherein the sonar detector is configured to have a maximum working pressure of 40 MPa and a maximum working temperature of 100°C.

10. A method for detecting a topography of a deep underground horizontal rock-salt cavern, based on a device for detecting a topography of a deep underground horizontal rock-salt cavern according to claim 1, comprising the following steps:
S1, selecting, according to geological information of salt mining and cavern construction, a horizontal rock-salt cavern to be detected;
S2, performing a workover operation on a shaft of the horizontal rock-salt cavern and filling the horizontal rock-salt cavern with water to ensure that the detector is smoothly lowerable, is able to travel in the cavern and is recoverable;
S3, lowering the detector from the shaft, and turning on the ground monitoring system and the positioning system during the lowering to monitor a lowering position in real time;
S4, turning on the propulsion system, the sonar detector and the obstacle avoidance system after the detector is lowered into the horizontal rock-salt cavern, the detector, while traveling in the horizontal rock-salt cavern, scanning the topography of the horizontal rock-salt cavern through the sonar detector, and transmitting real-time detection data to the ground center console through the optical fiber cable, and performing three-dimensional reconstruction to obtain the topography of the cavern;
S5, turning off the sonar detector upon completion of the detection, planning an optimal return path based on the topography of the horizontal cavern obtained in S4 and data of the positioning system, and giving an instruction through the ground center console to control the detector to return to the shaft;
S6, distributing power of the propulsion system through the ground center console, adjusting an attitude of the detector to cause the detector to be parallel to the shaft, and removing the detector from the shaft through the optical fiber cable; and
S7, processing and analyzing information stored in the ground center console to obtain a shape, a size and a volume of the horizontal rock-salt cavern, so as to complete the detection.

11. A method for detecting a topography of a deep underground horizontal rock-salt cavern, based on a device for detecting a topography of a deep underground horizontal rock-salt cavern according to claim 2, comprising the following steps:
S1, selecting, according to geological information of salt mining and cavern construction, a horizontal rock-salt cavern to be detected;
S2, performing a workover operation on a shaft of the horizontal rock-salt cavern and filling the horizontal rock-salt cavern with water to ensure that the detector is smoothly lowerable, is able to travel in the cavern and is recoverable;
S3, lowering the detector from the shaft, and turning on the ground monitoring system and the positioning system during the lowering to monitor a lowering position in real time;
S4, turning on the propulsion system, the sonar detector and the obstacle avoidance system after the detector is lowered into the horizontal rock-salt cavern, the detector, while traveling in the horizontal rock-salt cavern, scanning the topography of the horizontal rock-salt cavern through the sonar detector, and transmitting real-time detection data to the ground center console through the optical fiber cable, and performing three-dimensional reconstruction to obtain the topography of the cavern;
S5, turning off the sonar detector upon completion of the detection, planning an optimal return path based on the topography of the horizontal cavern obtained in S4 and data of the positioning system, and giving an instruction through the ground center console to control the detector to return to the shaft;
S6, distributing power of the propulsion system through the ground center console, adjusting an attitude of the detector to cause the detector to be parallel to the shaft, and removing the detector from the shaft through the optical fiber cable; and
S7, processing and analyzing information stored in the ground center console to obtain a shape, a size and a volume of the horizontal rock-salt cavern, so as to complete the detection.

12. A method for detecting a topography of a deep underground horizontal rock-salt cavern, based on a device for detecting a topography of a deep underground horizontal rock-salt cavern according to claim 3, comprising the following steps:
S1, selecting, according to geological information of salt mining and cavern construction, a horizontal rock-salt cavern to be detected;
S2, performing a workover operation on a shaft of the horizontal rock-salt cavern and filling the horizontal rock-salt cavern with water to ensure that the detector is smoothly lowerable, is able to travel in the cavern and is recoverable;
S3, lowering the detector from the shaft, and turning on the ground monitoring system and the positioning system during the lowering to monitor a lowering position in real time;
S4, turning on the propulsion system, the sonar detector and the obstacle avoidance system after the detector is lowered into the horizontal rock-salt cavern, the detector, while traveling in the horizontal rock-salt cavern, scanning the topography of the horizontal rock-salt cavern through the sonar detector, and transmitting real-time detection data to the ground center console through the optical fiber cable, and performing three-dimensional reconstruction to obtain the topography of the cavern;
S5, turning off the sonar detector upon completion of the detection, planning an optimal return path based on the topography of the horizontal cavern obtained in S4 and data of the positioning system, and giving an instruction through the ground center console to control the detector to return to the shaft;
S6, distributing power of the propulsion system through the ground center console, adjusting an attitude of the detector to cause the detector to be parallel to the shaft, and removing the detector from the shaft through the optical fiber cable; and
S7, processing and analyzing information stored in the ground center console to obtain a shape, a size and a volume of the horizontal rock-salt cavern, so as to complete the detection.

13. A method for detecting a topography of a deep underground horizontal rock-salt cavern, based on a device for detecting a topography of a deep underground horizontal rock-salt cavern according to claim 4, comprising the following steps:
S1, selecting, according to geological information of salt mining and cavern construction, a horizontal rock-salt cavern to be detected;
S2, performing a workover operation on a shaft of the horizontal rock-salt cavern and filling the horizontal rock-salt cavern with water to ensure that the detector is smoothly lowerable, is able to travel in the cavern and is recoverable;
S3, lowering the detector from the shaft, and turning on the ground monitoring system and the positioning system during the lowering to monitor a lowering position in real time;
S4, turning on the propulsion system, the sonar detector and the obstacle avoidance system after the detector is lowered into the horizontal rock-salt cavern, the detector, while traveling in the horizontal rock-salt cavern, scanning the topography of the horizontal rock-salt cavern through the sonar detector, and transmitting real-time detection data to the ground center console through the optical fiber cable, and performing three-dimensional reconstruction to obtain the topography of the cavern;
S5, turning off the sonar detector upon completion of the detection, planning an optimal return path based on the topography of the horizontal cavern obtained in S4 and data of the positioning system, and giving an instruction through the ground center console to control the detector to return to the shaft;
S6, distributing power of the propulsion system through the ground center console, adjusting an attitude of the detector to cause the detector to be parallel to the shaft, and removing the detector from the shaft through the optical fiber cable; and
S7, processing and analyzing information stored in the ground center console to obtain a shape, a size and a volume of the horizontal rock-salt cavern, so as to complete the detection.

14. A method for detecting a topography of a deep underground horizontal rock-salt cavern, based on a device for detecting a topography of a deep underground horizontal rock-salt cavern according to claim 5, comprising the following steps:
S1, selecting, according to geological information of salt mining and cavern construction, a horizontal rock-salt cavern to be detected;
S2, performing a workover operation on a shaft of the horizontal rock-salt cavern and filling the horizontal rock-salt cavern with water to ensure that the detector is smoothly lowerable, is able to travel in the cavern and is recoverable;
S3, lowering the detector from the shaft, and turning on the ground monitoring system and the positioning system during the lowering to monitor a lowering position in real time;
S4, turning on the propulsion system, the sonar detector and the obstacle avoidance system after the detector is lowered into the horizontal rock-salt cavern, the detector, while traveling in the horizontal rock-salt cavern, scanning the topography of the horizontal rock-salt cavern through the sonar detector, and transmitting real-time detection data to the ground center console through the optical fiber cable, and performing three-dimensional reconstruction to obtain the topography of the cavern;
S5, turning off the sonar detector upon completion of the detection, planning an optimal return path based on the topography of the horizontal cavern obtained in S4 and data of the positioning system, and giving an instruction through the ground center console to control the detector to return to the shaft;
S6, distributing power of the propulsion system through the ground center console, adjusting an attitude of the detector to cause the detector to be parallel to the shaft, and removing the detector from the shaft through the optical fiber cable; and
S7, processing and analyzing information stored in the ground center console to obtain a shape, a size and a volume of the horizontal rock-salt cavern, so as to complete the detection.

15. A method for detecting a topography of a deep underground horizontal rock-salt cavern, based on a device for detecting a topography of a deep underground horizontal rock-salt cavern according to claim 6, comprising the following steps:
S1, selecting, according to geological information of salt mining and cavern construction, a horizontal rock-salt cavern to be detected;
S2, performing a workover operation on a shaft of the horizontal rock-salt cavern and filling the horizontal rock-salt cavern with water to ensure that the detector is smoothly lowerable, is able to travel in the cavern and is recoverable;
S3, lowering the detector from the shaft, and turning on the ground monitoring system and the positioning system during the lowering to monitor a lowering position in real time;
S4, turning on the propulsion system, the sonar detector and the obstacle avoidance system after the detector is lowered into the horizontal rock-salt cavern, the detector, while traveling in the horizontal rock-salt cavern, scanning the topography of the horizontal rock-salt cavern through the sonar detector, and transmitting real-time detection data to the ground center console through the optical fiber cable, and performing three-dimensional reconstruction to obtain the topography of the cavern;
S5, turning off the sonar detector upon completion of the detection, planning an optimal return path based on the topography of the horizontal cavern obtained in S4 and data of the positioning system, and giving an instruction through the ground center console to control the detector to return to the shaft;
S6, distributing power of the propulsion system through the ground center console, adjusting an attitude of the detector to cause the detector to be parallel to the shaft, and removing the detector from the shaft through the optical fiber cable; and
S7, processing and analyzing information stored in the ground center console to obtain a shape, a size and a volume of the horizontal rock-salt cavern, so as to complete the detection.

16. A method for detecting a topography of a deep underground horizontal rock-salt cavern, based on a device for detecting a topography of a deep underground horizontal rock-salt cavern according to claim 7, comprising the following steps:
S1, selecting, according to geological information of salt mining and cavern construction, a horizontal rock-salt cavern to be detected;
S2, performing a workover operation on a shaft of the horizontal rock-salt cavern and filling the horizontal rock-salt cavern with water to ensure that the detector is smoothly lowerable, is able to travel in the cavern and is recoverable;
S3, lowering the detector from the shaft, and turning on the ground monitoring system and the positioning system during the lowering to monitor a lowering position in real time;
S4, turning on the propulsion system, the sonar detector and the obstacle avoidance system after the detector is lowered into the horizontal rock-salt cavern, the detector, while traveling in the horizontal rock-salt cavern, scanning the topography of the horizontal rock-salt cavern through the sonar detector, and transmitting real-time detection data to the ground center console through the optical fiber cable, and performing three-dimensional reconstruction to obtain the topography of the cavern;
S5, turning off the sonar detector upon completion of the detection, planning an optimal return path based on the topography of the horizontal cavern obtained in S4 and data of the positioning system, and giving an instruction through the ground center console to control the detector to return to the shaft;
S6, distributing power of the propulsion system through the ground center console, adjusting an attitude of the detector to cause the detector to be parallel to the shaft, and removing the detector from the shaft through the optical fiber cable; and
S7, processing and analyzing information stored in the ground center console to obtain a shape, a size and a volume of the horizontal rock-salt cavern, so as to complete the detection.

17. A method for detecting a topography of a deep underground horizontal rock-salt cavern, based on a device for detecting a topography of a deep underground horizontal rock-salt cavern according to claim 8, comprising the following steps:
S1, selecting, according to geological information of salt mining and cavern construction, a horizontal rock-salt cavern to be detected;
S2, performing a workover operation on a shaft of the horizontal rock-salt cavern and filling the horizontal rock-salt cavern with water to ensure that the detector is smoothly lowerable, is able to travel in the cavern and is recoverable;
S3, lowering the detector from the shaft, and turning on the ground monitoring system and the positioning system during the lowering to monitor a lowering position in real time;
S4, turning on the propulsion system, the sonar detector and the obstacle avoidance system after the detector is lowered into the horizontal rock-salt cavern, the detector, while traveling in the horizontal rock-salt cavern, scanning the topography of the horizontal rock-salt cavern through the sonar detector, and transmitting real-time detection data to the ground center console through the optical fiber cable, and performing three-dimensional reconstruction to obtain the topography of the cavern;
S5, turning off the sonar detector upon completion of the detection, planning an optimal return path based on the topography of the horizontal cavern obtained in S4 and data of the positioning system, and giving an instruction through the ground center console to control the detector to return to the shaft;
S6, distributing power of the propulsion system through the ground center console, adjusting an attitude of the detector to cause the detector to be parallel to the shaft, and removing the detector from the shaft through the optical fiber cable; and
S7, processing and analyzing information stored in the ground center console to obtain a shape, a size and a volume of the horizontal rock-salt cavern, so as to complete the detection.

18. A method for detecting a topography of a deep underground horizontal rock-salt cavern, based on a device for detecting a topography of a deep underground horizontal rock-salt cavern according to claim 9, comprising the following steps:
S1, selecting, according to geological information of salt mining and cavern construction, a horizontal rock-salt cavern to be detected;
S2, performing a workover operation on a shaft of the horizontal rock-salt cavern and filling the horizontal rock-salt cavern with water to ensure that the detector is smoothly lowerable, is able to travel in the cavern and is recoverable;
S3, lowering the detector from the shaft, and turning on the ground monitoring system and the positioning system during the lowering to monitor a lowering position in real time;
S4, turning on the propulsion system, the sonar detector and the obstacle avoidance system after the detector is lowered into the horizontal rock-salt cavern, the detector, while traveling in the horizontal rock-salt cavern, scanning the topography of the horizontal rock-salt cavern through the sonar detector, and transmitting real-time detection data to the ground center console through the optical fiber cable, and performing three-dimensional reconstruction to obtain the topography of the cavern;
S5, turning off the sonar detector upon completion of the detection, planning an optimal return path based on the topography of the horizontal cavern obtained in S4 and data of the positioning system, and giving an instruction through the ground center console to control the detector to return to the shaft;
S6, distributing power of the propulsion system through the ground center console, adjusting an attitude of the detector to cause the detector to be parallel to the shaft, and removing the detector from the shaft through the optical fiber cable; and
S7, processing and analyzing information stored in the ground center console to obtain a shape, a size and a volume of the horizontal rock-salt cavern, so as to complete the detection.
